(19) United States
(12) Patent Application Publication
(10) Pub. No.: US 2005/0191574 A1
(43) Pub. Date: Sep. 1, 2005

(54) Method and apparatus for electrophotographic image forming capable of using a toner enhancing image quality and cleanability, and the toner used in the image forming

(76) Inventors: Toshio Koike, Kawasaki-shi (JP); Tokuya Ojimi, Kawasaki-shi (JP); Takaaki Tawada, Yokohama-shi (JP); Takeshi Shintani, Kawasaki-shi (JP); Yuji Arai, Kawasaki-shi (JP); Takuzu Yoneda, Ohta-ku (JP); Masanori Kawasumi, Yokohama-shi (JP); Masami Tomita, Numazu-shi (JP); Kazuhiko Umemura, Suntou-gun (JP); Ken Amemiya, Nerima-ku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/060,421

(22) Filed: Feb. 18, 2005

(30) Foreign Application Priority Data
Feb. 19, 2004 (JP) 2004-042210

(51) Int. Cl. G03G 9/087

(52) U.S. Cl. 430/109.4; 430/125; 430/111.4; 399/350

(57) ABSTRACT

An image forming apparatus performs electrophotographic image forming using a toner and includes an image bearing member configured to bear an electrostatic latent image on a surface thereof, a developing mechanism configured to develop the electrostatic latent image in to a toner image by using a toner, a transfer mechanism configured to transfer the toner image from the image bearing member to an image receiver, a cleaning mechanism including a cleaning blade and configured to remove a residual toner on the image bearing member after toner image is transferred to the image receiver. The toner includes a binder resin and a colorant, forms a toner powder layer, and satisfies an inequality Y≧−0.05X+0.029, in which “X” expresses a porosity of the toner powder layer after uniformly compressed at a constant force and “Y” expresses a torque value obtained by rotatably sticking a conical rotor into the toner powder layer.

### CROSS REFERENCE TO RELATED APPLICATIONS

The present application claims priority under 35 U.S.C. § 119 to Japanese Patent Application No. 2004-042210 filed on Feb. 19, 2004 in the Japanese Patent Office, the entire contents of which are hereby incorporated herein by reference.

### BACKGROUND OF THE INVENTION

1. Field of the Invention

The present invention relates to a method and apparatus for electrophotographic image forming and a toner used in the image forming. In particular, the present invention relates to a method and apparatus for electrophotographic image forming capable of using a toner enhancing image quality and cleanability without causing deterioration of a cleaning blade, and a toner used in the image forming enhancing image quality and cleanability.

2. Discussion of the Background

In a background image forming apparatus, an electrophotographic image forming method is widely used for copiers, facsimile machines, laser printers, etc. The background image forming apparatus with the electrophotographic image forming method generally performs image forming operations as follows:
A charging unit uniformly charges a surface of an image bearing member;
A writing unit emits a laser beam and irradiates the surface of the image bearing member to form an electrostatic latent image thereon;
A developing unit supplies a developer to the surface of the image bearing member to visualize the electrostatic latent image thereon as a toner image;
The toner image formed on the image bearing member is transferred onto a receiving material such as a transfer sheet directly or via an intermediate transfer member;
The toner image formed on the receiving material is conveyed to a fixing unit to be fixed by heat and pressure; and
The fixed toner image is discharged to an sheet discharging portion.

At the same time, a cleaning unit removes toner remaining on the surface of the image bearing member so that the image bearing member can repeatedly be used.

Toner used in the background image forming apparatus with the electrophotographic image forming method has been obtained as follows. Colorants such as dye, pigment, carbon black, etc. are dispersed into a binder resin formed of a natural or synthetic high-molecular material. The toner obtained as described above is further pulverized so that excessively fine toner particles are generated.

The toner used for electrophotographic image forming needs to include various characteristics for performing sufficient printing. These characteristics are, for example, mechanical characteristics such as a particle diameter, shape, specific gravity, fluidity, etc., electrical characteristics such as electric resistance, dielectric constant, etc., thermal characteristics such as softening point, melting point, etc., optical characteristics, safety, self life, etc. Among the above-described characteristics, the fluidity of toner is important because it has an affect on stability in replenishing toner form a hopper of a developing unit and collectability of toner from a cleaning unit.

Further, in recent years copiers and printers have been providing images in higher quality, and small dot reproducibility has been more important. Since the dot reproducibility is affected by the fluidity of toner as well as charge amounts of toner and developer, a uniform layer of toner or developer needs to be stably supplied to an electrostatic latent image having fine dots and lines.

There are some techniques related to toner used in electrophotographic image forming.

In one technique, fluidity of developer (i.e., toner) accommodated in a developing unit is evaluated by measuring a period of time required for a constant amount of the developer to fall from the developing unit through a funnel having a narrow part in which a magnetic field is applied.

In another technique, inclining angles are measured at a start and end of flow of a developer. A platform is firstly placed horizontally and the developer is put in a box. As the platform is gradually inclined, the developer starts flowing. At that time, an inclining angle at the start of flow of the developer is confirmed. Then, the plat form is inclined more and more every time the developer stops flowing, and the final inclining angle is confirmed when the developer finishes flowing.

In another technique, fluidity of toner is evaluated by calculations. Toner is supplied into a plurality of sieves and is imparted by vibration generated by horizontal and perpendicular vibration devices. Respective weights of toner remained in the plurality of sieves and a container measured by a measuring instrument are multiplied by respective coefficients previously set for the plurality of sieves and the container. Thus obtained evaluation values are used for calculations to evaluate the fluidity of toner.

However, the results of the above-described techniques may include variations of data and of skills of examiners. Therefore, difference of fluidity of fine toner particles could not be evaluated.

Recently, with images in higher quality, toner used in an image forming apparatus has become smaller and more functional. Since such smaller and more functional toner has a more complex structure, detailed controls in toner manufacturing are required. Specially, the fluidity of toner has a key to good dot reproducibility and other image qualities. Therefore, an evaluating method with high accuracy is needed.

The fluidity of toner may substantially vary with respect to conditions in toner manufacturing when the toner manufacturing method is changed from a pulverization method to other methods such as a polymerization method. Compared to the pulverization method, the polymerization method needs more detailed controls and evaluations in toner manufacturing.

To eliminate the above-described problem, another technique has bee proposed. In the technique, toner and its fluidity are quantified so that a porosity of a toner layer that is compressed for a predetermined period of time may be controlled in a range from 0.51 to 0.54, that is, in a range from 51.0% to 54.0%.

However, the above-described technique may derive the same porosities when frictional resistances on a surface of a toner particle are different. Therefore, the above-described technique has not been sufficient for evaluating differences of fluidity of toner. In addition, the above-described technique has not shown porosities of toner without additive.

On the other hand, there are various types of cleaning units employing various methods. For example, cleaning units may employ any of a cleaning blade, a fur brush roller including a plurality of conductive or insulating fibers, a cleaning roller including a lubricant therein, a magnetic brush roller including magnetic powder on a surface thereof, a suctioning device, etc. Among the above-described cleaning units, the cleaning unit with the cleaning blade is most commonly known. The cleaning unit using the cleaning blade has a simple structure and high toner cleanability.

However, when a toner particle in which an average particle diameter distribution of toner is equal to or less than 7 μm or a toner particle having a spherical shape is used for high image quality, it is difficult for the above-described methods to obtain a margin of cleanability.

For manufacturing small toner particles, from a manufacturing cost standpoint, a polymerization method is preferable to a background manufacturing method such as a pulverization method. A polymerized toner having a small particle diameter has a substantially spherical form and a sharp particle diameter distribution of toner, thereby obtaining a high quality image with good fine line reproducibility and good dot reproducibility in a production of digital images.

When the polymerized toner having a small particle diameter is used, the polymerized toner particle is more spherical and smaller than a pulverized toner particle. Therefore, it is difficult to clean the toner particle remaining on, for example, a surface of an image bearing member. Such toner particle having a minuscule spherical form may easily roll into a space between an image bearing member and a cleaning member, resulting in a cleaning failure such as black dots on a background of an image. When a cleaning blade having an edge that may be abraded or cracked is used, the cleaning failure may easily occur. With the deformed cleaning blade, the image bearing member contacting with the cleaning blade may be abraded to change the surface of the image bearing member to be odd-shaped or indented, thereby causing a cleaning failure on the surface of the image bearing member.

To prevent abrasion and crack of the cleaning blade, some techniques in which applying a lubricant on a surface of the cleaning blade is widely used.

In one of the above-described techniques, a constant amount of toner is supplied for use as a lubricant. However, when the toner particles easily roll into a space between the cleaning blade and an image bearing member, the constant amount of toner supplied to the cleaning blade may facilitate abrasion of the cleaning blade.

In another technique using the lubricant, a property of a cleaning blade is specified so as to enhance a stability of use of the cleaning blade. However, this technique is not sufficient to obtain a better cleanability and durability when a small toner particle having a spherical form is used.

In another technique, repulsion elasticity obtained at relatively high temperatures in a range of from 30 degree Celsius to 40 degree Celsius is specified so that deterioration of a cleaning blade can be prevented. That is, a spherical toner particle is used with a cleaning blade having repulsion elasticity of 5% to 30% at a temperature of 30 degree Celsius and 10% to 40% at a temperature of 40 degree Celsius.

However, a desired cleanability is not sufficiently achieved with the above-described technique. As previously mentioned, when residual spherical toner particles may cause the cleaning failure by falling to a space between the cleaning blade and the image bearing member, resulting in poor image quality.

Further, in one technique, an additive having a predetermined form is supplied as a cleaning auxiliary agent. In another technique, toner obtained by mixing a pulverized toner with a polymerized toner is supplied as a cleaning auxiliary agent.

However, those techniques may cause an excess or shortage of the cleaning auxiliary agents, and result in a lack of stability.

To increase cleanability for cleaning toner having a spherical form, a pressure to a contacting portion of a cleaning blade with respect to an image bearing member is increased. However, while the cleaning blade is contacting the image bearing member with high pressure, the surface of the image bearing member may easily be abraded, and may not have high durability.

### SUMMARY OF THE INVENTION

The present invention has been made in view of the above-described circumstances.

An object of the present invention is to provide an electrophotographic image forming apparatus capable of using a toner of minuscule spherical particles with superior image quality and cleanability without causing deterioration of a cleaning blade.

Another object of the present invention is to provide a toner that has minuscule spherical particles, can be cleaned by a cleaning blade, and can maintain superior image quality and enhance cleanability without causing deterioration of the cleaning blade.

In one exemplary embodiment, a novel image forming apparatus performs electrophotographic image forming using a toner and includes an image bearing member, a developer containing toner, a transferor, and a cleaner. The image bearing member is configured to bear an electrostatic latent image on a surface thereof. The developer is configured to develop the electrostatic latent image formed on the surface of the image bearing member into a toner image with the toner. The transferor is configured to transfer the toner image from the image bearing member to an image receiver. The cleaner includes a cleaning blade and is configured to remove a residual toner on the surface of the image bearing member after the toner image is transferred to the image receiver. The toner used in the novel image forming apparatus includes a binder resin and a colorant. The toner forms a toner powder layer, and satisfies an inequality Y≧−0.05X+0.029, in which “X” expresses a porosity of the toner powder layer after uniformly compressed at a constant force and “Y” expresses a torque value obtained by rotatably sticking a conical rotor into the toner powder layer.

The cleaning blade may have a JIS-A hardness equal to or more than 65.

The toner used in the above-described novel image forming apparatus may be obtained from at least one of elongation and crosslinking reaction of toner composition in an organic solvent and including a polyester prepolymer having a function group including nitrogen atom, a polyester, a colorant, and a releasing agent in an aqueous medium under resin fine particles.

The toner used in the novel image forming apparatus may have an average circularity of from approximately 0.93 to approximately 1.00.

The toner used in the above-described novel image forming apparatus may have a volume-based average particle diameter equal to or less than 10 μm and a distribution from approximately 1.00 to approximately 1.40, wherein the distribution is defined by a ratio of the volume-based average particle diameter to a number-based average particle diameter.

The toner used in the above-described novel image forming apparatus may have a spindle outer shape, and a ratio of a major axis r1 to a minor axis r2 from approximately 0.5 to approximately 1.0 and a ratio of a thickness r3 to the minor axis r2 from approximately 0.7 to approximately 1.0, and r1≧r2≧r3.

In one exemplary embodiment, a novel method of electrophotographic image forming includes forming an electrostatic latent image on a surface of an image bearing member, developing a toner image with a toner based on the electrostatic latent image formed on the surface of the image bearing member, transferring the toner image with a transfer mechanism from the image bearing member to an image receiver, and removing a residual toner on the surface of the image bearing member using a cleaning blade after the toner image is transferred to the image receiver. The toner used in the above-described novel method may include at least a binder resin and a colorant, form a toner powder layer, and satisfy an inequality Y≧−0.05X+0.029, in which “X” expresses a porosity of the toner powder layer after uniformly compressed at a constant force and “Y” expresses a torque value obtained by rotatably sticking a conical rotor into the toner powder layer.

In one exemplary embodiment, a novel toner includes a binder resin and colorant. The novel toner forms a toner powder layer and satisfies an inequality Y≧−0.05X+0.029, in which “X” expresses a porosity of the toner powder layer after uniformly compressed at a constant force and “Y” expresses a torque value obtained by rotatably sticking a conical rotor into the toner powder layer.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic structure of an image forming unit and peripheral components for image forming of an electrophotographic image forming apparatus according to an exemplary embodiment of the present invention;

FIG. 2 is a schematic structure of a device for evaluating fluidity of toner with a conical rotor;

FIG. 3A is a drawing of a toner having an “SF1” shape factor and FIG. 3B is a drawing of a toner having an “SF2” shape factor;

FIG. 4A is an outer shape of a toner used in the image forming unit of FIG. 1, FIGS. 4B and 4C are schematic cross sectional views of the toner, showing major and minor axes and a thickness of FIG. 4A;

FIG. 5 is a graph showing a relationship of a property of a torque of toners and the cleaning remaining ΔID;

FIG. 6 is a graph showing a relationship of a property of a porosity of toners and the cleaning remaining ΔID; and

FIG. 7 is a graph showing results of tests performed according to the exemplary embodiment of the present invention.

### DETAILED DESCRIPTION OF THE PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, preferred embodiments of the present invention are described.

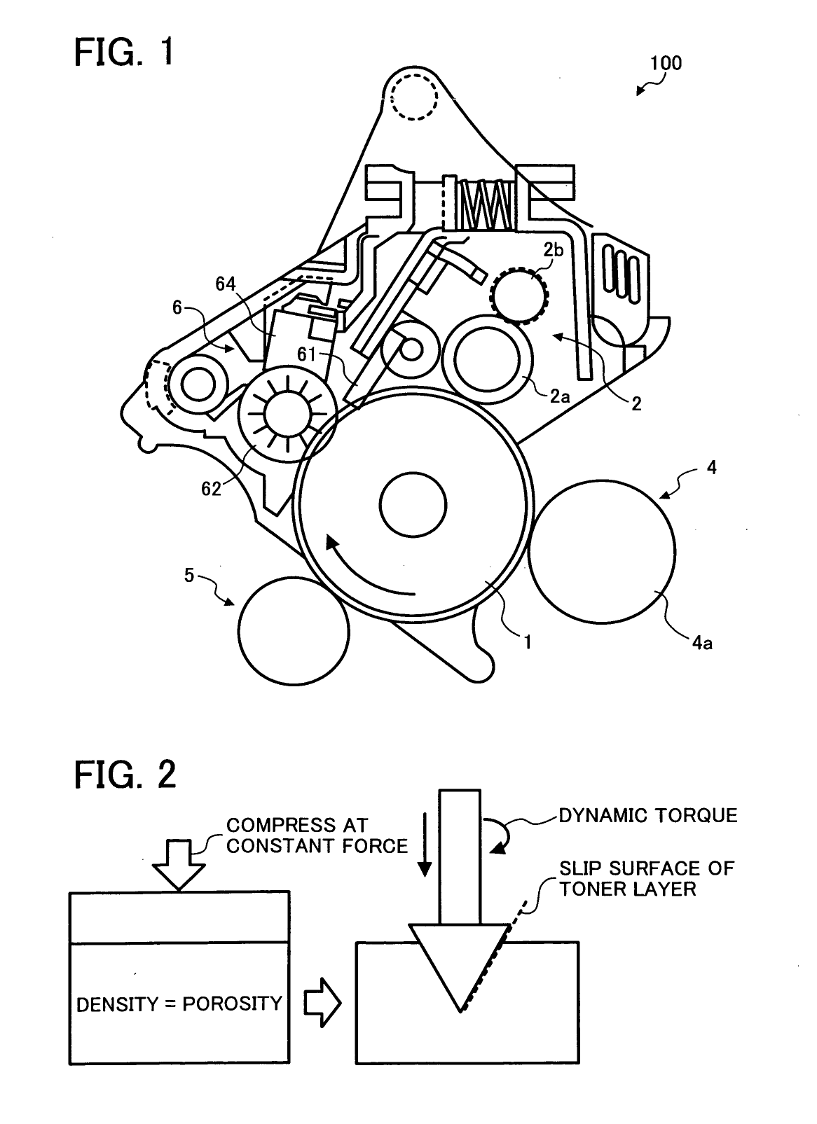

Referring to FIG. 1, a schematic structure of an image forming unit 100 of an image forming apparatus (not shown) according to an exemplary embodiment of the present invention is described.

The image forming unit 100 of FIG. 1 includes a photoconductive element 1, a charging unit 2, a developing unit 4, a transfer unit 5, a cleaning unit 6, a writing unit (not shown), and a fixing unit (not shown).

The charging unit 2 uniformly charges a surface of the photoconductive element 1.

The writing unit emits a laser beam and irradiates the surface of the photoconductive element 1 to form an electrostatic latent image thereon.

The developing unit 4 supplies a developer to the surface of the photoconductive element 1 to visualize the electrostatic latent image thereon as a toner image.

The toner image formed on the photoconductive element 1 is transferred onto a receiving material such as a transfer sheet directly or via an intermediate transfer member (not shown).

The toner image formed on the receiving material is conveyed to the fixing unit to be fixed by heat and pressure. The fixed toner image is discharged to a sheet discharging portion (not shown).

At the same time, the cleaning unit 6 removes toner remaining on the surface of the photoconductive element 1 so that the photoconductive element 1 can repeatedly be used.

The photoconductive element 1 can include an amorphous metal like amorphous silicone, amorphous selenium, etc. which are photoconductive, and an organic compound like bisazo pigments and phthalocyanine pigments, etc. In the light of environment and disposal after use, it is preferable to use an OPC (organic photo conductor) element having an organic compound.

The charging unit 2 may employ any one of a corona charging method, a roller charging method, a brush charging method, and a blade charging method. The charging unit 2 in this embodiment employs a roller charging method. The charging unit 2 includes a charging roller 2a, a charging roller cleaning member 2b, and a power supply (not shown). The charging roller cleaning member 2b is held in contact with the charging roller 2a for the purpose of cleaning. The power supply is connected with the charging roller 2a. A high voltage is applied to the charging roller 2a to apply a predetermined voltage between the photoconductive element 1 and the charging roller 2a. Then, corona discharge is generated between the photoconductive element 1 and the charging roller 2a, thereby uniformly charging a surface of the photoconductive element 1.

The developing unit 4 includes a developer bearing member 4a and a toner supply chamber (not shown).

The developer bearing member 4a bears a developer to supply the developer to the photoconductive element 1. The developer bearing member 4a includes a hollow developer cylinder that is rotatably supported inside the developer bearing member 4a and a magnet roll that is fixed to the same shaft inside the hollow developer cylinder. A developer adheres magnetically on an outer peripheral surface of the hollow developer cylinder to be conveyed further. The hollow developer cylinder includes a photoconductive and non-magnetic material. A power supply (not shown) for applying of developing bias is connected to the hollow developer cylinder. The voltage is applied between the developer bearing member 4a and the photosensitive drum 1 by the power supply, thereby forming an electric field in an area of developing.

The cleaning unit 6 includes a cleaning blade 61, a lubricant supplying unit 62, and a molded lubricant 64.

The cleaning blade 61 is held in contact with the photoconductive element 1.

The lubricant supplying unit 62 is arranged upstream of the cleaning blade 61 in a rotation of the photoconductive element 1. The lubricant supplying unit 62 abrasively scrapes the molded lubricant 64 to apply the scraped lubricant to the photoconductive element 1. The lubricant supplying unit 62 also includes a function as a toner removing unit. After a primary transfer operation, the lubricant supplying unit 62 serving as the toner removing unit removes toner remaining on the surface of the photoconductive element 1. Subsequently, the lubricant supplying unit 62 supplies small particles of lubricant scraped from the molded lubricant 64, so that the toner remaining on the surface of the photoconductive element 1 is finally removed by the cleaning blade 61 to prevent problems such as a toner filming.

The lubricant supplying unit 62 serving as the toner removing unit may include a brush roller as shown in FIG. 1. The brush roller includes a resin such as nylon, carbon, etc. added by a resistivity control material such as carbon black, and is controlled to have a volume resistivity in a range of from approximately 1×10³ Ωcm to approximately 1×10⁸ Ωcm. The brush roller is arranged in a vicinity of the molded lubricant 64 as the molded lubricant 64 contacts by its own weight with the brush roller.

Specific examples of the molded lubricant 64 are metal salts of fatty acids such as lead oleate, zinc oleate, copper oleate, zinc stearate, cobalt stearate, iron stearate, copper stearate, zinc palmitate, copper palmitate, and zinc linoleate. Among the metal salts of fatty acids, zinc stearate is preferable.

The brush roller rotatably scrapes the molded lubricant 64 to supply fine lubricant particles onto the surface of the photoconductive element 1. When the cleaning blade 61 contacts the photoconductive element 1, the fine lubricant particles are spread to form a thin film layer so that a friction coefficient of the surface of the photoconductive element 1 may be reduced. Further, the above-described brush roller can effectively reduce an amount of toner conveyed to the cleaning blade 61 when an image having high image area coverage is formed using a smaller and more spherical toner particle, thereby increasing the cleanability.

When a modulus of repulsion elasticity of the cleaning blade 61 for scraping toner remaining on the surface of the photoconductive element 1 is equal to or lower than 40% in a range of from 10 degree Celsius to 40 degree Celsius, the cleaning blade 61 may reduce squeaking and chattering sounds and the photoconductive element 1 may be prevented from abrasion. It is because the modulus of repulsion elasticity of the cleaning blade 61 is low, self-induced vibration such as stick slip may less occur at a contact point of the cleaning blade 61 and the photoconductive element 1, result in less abrasion of the surface of the photoconductive element 1.

Further, the cleanability may increase when the cleaning blade 61 is belt by five degree and when a modulus of flexural rigidity of the cleaning blade 61 obtained at a point that is 5 mm away from a fulcrum of the cleaning blade 61 is equal to or greater than 400 mN. If the modulus of flexural rigidity of the cleaning blade 61 is less than 400 mN, a linear pressure applied to a portion in which the cleaning blade 61 contacts the photoconductive element 1 may become lower, and a force to prevent the toner falling through the space between the cleaning blade 61 and the photoconductive element 1 may become weaker.

When the cleaning blade has a degree of hardness equal to or greater than 65 by JIS-A (Japanese Industrial Standards, Division A), the cleanability may increase. When the cleaning blade has a degree of hardness less than 65 by JIS-A, the cleaning blade 61 held in contact with the photoconductive element 1 may easily be deformed and the area in which the cleaning blade 61 contacts the photoconductive element 1. If the area the cleaning blade 61 contacts the photoconductive element 1 is increased, a contact pressure to the area may be decreased, resulting in an increase of toner passing through the space between the cleaning blade 61 and the photoconductive element 1. Further, when the toner is pushed to the edge of the cleaning blade 61, the cleaning blade 61 cannot apply a sufficient power to push back the toner, resulting in an increase of toner passing through the above-described space.

The cleaning blade 61 may be made of liquid thermosetting materials such as urethane rubber.

The cleaning blade 61 can be prepared, in particular, by a method such as one-shot methods, prepolymer methods, and pseudo one-shot methods that stand between the one-shot methods and prepolymer methods.

Main components of suitable liquid thermosetting materials are, for example, prepolymer for urethane rubber and curing agent. The prepolymer for urethane rubber is obtained by partially polymerizing polyisocyanate and polyol.

Specific examples of the polyisocyanate are, for example, 4,4′-diphenylmethane diisocyanate (MDI), isophorone diisocyanate (IPDI), 4,4′-dicyclohexylmethane diisocyanate (hydrogenerated MDI), trimethyl hexamethylene diisocyanate (TMHDI), tolylene diisocyanate (TDI), carbodiimid modified MDI, polymethylene phenyl polyisocyanate (PAPI), ortho-toluidine isocyanate (TODI), naphthylene diisocyanate (NDI), xylylene diisocyanate (XDI), hexamethylene diisocyanate (HMDI), para-phenylene diisocyanate (PDI), lysine diisocyanate methyl ester (LDI), dimeryl diisocyanate (DDI). Among the above-described polyisocyanate, MDI and TODI are preferably used.

Specific examples of the polyol for use with the polyisocyanate are, for example, polyester polyols such as polyethylene adipate, polybutylene adipate, polyhexylene adipate, copolymer of ethylene adipate and butylenes adipate; and polyether polyols such as polycaprolactone, polyoxy tetramethylene glycol, polyoxy propylene glycol. Among these polyols, a polyol having a molecular weight in a range from approximately 1,500 to approximately 3000 is preferably used. When an amount of the molecular weight is less than 1,500, physical properties of urethane rubber tend to deteriorate. When an amount of the molecular weight exceeds 3,000, viscosity of prepolymer tends to increase, which may deteriorate activity of cleaning blade forming.

Prepolymer for the urethane rubber is prepared with the polyisocyanate and the polyol, for example. The polyisocyanate and the polyol are mixed, then the mixture is reacted at a temperature of from 80 to 120 degree Celsius for 30 to 90 minutes. Thus, the prepolymer can be obtained.

It is preferable that the curing agent of prepolymer for the above-described urethane rubber is a low molecular weight polyol having the molecular weight equal to or less than 300.

Specific examples of the polyol are, for example, ethylene glycol (EG), diethylene glycol (DEG), propylene glycol (PG), dipropylene glycol (DPG), 1,4-butanediol (14BD), hexanediol (HD), 1,4-cyclohexane diol, 1,4-cyclohexane dimethanol, xylene glycol (telephthalyl alcohol), triethylene glycol, trimethylolpropane, glycerin, pentaerythritol and sorbitol.

From a viewpoint of an easiness of mixture and a characteristic of the cleaning blade, a combination of MDI and polyester polyol is preferably used as a prepolymer and a combination of 1,4-butanediol, trimethylolpropane, and polyester polyol is preferably used as the curing agent. A combination of MDI and polyethylene adipate is more preferably used as the prepolymer, and a combination of 1,4-butanediol and trimethylolpropane is more preferably used as the curing agent.

Referring to FIG. 2, a measurement of torques or loads generated in a toner powder layer for evaluating fluidity of toner is described.

The evaluating method is not particularly limited. In the present invention, a method using a conical rotor is used to evaluate the fluidity of toner. The purpose of this measurement was to evaluate fluidity of toner according to the torques or the loads generated by a friction between toner particles in the toner powder layer.

The measurement was made using an instrument with the conical rotor. The instrument used for the measurement was developed and assembled in Ricoh Company, Ltd., and has not been introduced into the market as a product.

The conical rotor has grooves on its surface and is configured to rotate to stick into the toner powder layer. When the conical rotor moves in the toner powder layer, a friction may be generated between toner particles in the toner powder layer, so that the instrument can measure a torque or a load generated in the toner powder layer.

The shape of the conical rotor is not particularly limited. It is preferable that the conical rotor has a vertical angle of a circular cone thereof in a range from approximately 20 degree to approximately 150 degree.

When the vertical angle of the circular cone is less than 20 degree, resistance of the circular cone with respect to the toner becomes small, the torque and load also become small, and detailed differences in the fluidity cannot be evaluated.

When the vertical angle of the circular cone is greater than 150 degree, a force exerted to press the toner powder layer becomes large. Unnecessarily large force may easily deform toner particles in the toner powder layer, and the deformed toner particles are not preferable to evaluate the fluidity of toner.

The conical rotor is required to have a length such that a surface of the conical rotor may constantly stays in the toner powder layer.

The conical rotor has grooves on its surface. As previously described, the measurement was performed for evaluating fluidity of toner according to the torques or the loads generated by a friction between toner particles in the toner powder layer, not by a friction between the surface of the conical rotor and a toner particle. When the conical rotor having the grooves on the surface thereof is rotated to stick into the toner powder layer, some amount of the toner particles may fall into the grooves formed on the surface of the conical rotor, so that the friction between the toner particles in the grooves and other toner particles remaining in the toner powder layer and contacting the toner particles in the grooves can easily be measured.

The shape of the grooves formed on the surface of the conical rotor is not particularly limited. As previously described, the torques of this measurement was generated by a friction between toner particles in the toner powder layer, and the result of the measurement is not influenced by the shape of the grooves. However, a convex portion formed between the grooves is preferably formed a shape other than a flat surface. However, it is required a metallic portion of the conical rotor does not contact with toner particle around the metallic portion to prevent resistance from being generated. Therefore, the convex portion formed between the grooves needs to be formed not to have a flat surface but to have a linear feature, so that contact area of the conical rotor and a toner particle may be small as possible.

In FIG. 2, the conical rotor is rotated to stick into the toner powder layer straightly down from an apex of the circular cone towards a base of the toner powder layer to create a depression. A cross-section of the depression is a saw-toothed form having triangular hollow portions. The form of the groove In this case, the toner particle generally contacts with the conical rotor solely at the apex of the circular cone of the conical rotor. The toner particle usually contacts with another toner particle in the groove of the conical rotor.

The material of the conical rotor is not limited, but it is preferable the conical rotor includes a material that is easily processible and has a hard surface, no change in quality and no electrical charge. Examples of the materials of the conical rotor are SUS, AL, Cu, Au, Ag, brass, etc. The measurement values of the torques or the loads may not vary according to differences between the above-described materials.

A torque and load of the toner powder varies according to the number of rotations of the conical rotor, that is, the rotation number of the conical rotor per minute (hereinafter, referred to as “rpm”), and a speed of entry of the conical rotor into the toner powder layer. In this measurement, the rotation number and the speed of entry of the conical rotor are set to relatively low values so that subtle conditions of contact between the toner particles can be measured. Conditions of the measurements are as follows:
The number of rotations of conical rotor is set in a range from 0.1 rpm to 100 rpm; and
The speed of movement of conical rotor is set in a range from 0.5 mm/min to 150 mm/min.

When the number of rotations of the conical rotor is smaller than 0.1 rpm, subtle conditions of the toner powder layer may be affected and variations in torque values may be generated, which is not preferable to the measurement.

When the number of rotations of the conical rotor is greater than 100 rpm, toner failures such as scattering may occur, which is not preferable to the measurement.

When the speed of movement of the conical rotor into the toner powder layer is below 0.5 mm/min, subtle conditions of the toner powder layer may be affected and variations of toner may be generated, which is not preferable to the measurement.

When the speed of movement of the conical rotor into the toner powder layer is above 150 mm/min, the toner powder layer is overly pressed and the shape of toner may be deformed, which is not preferable to the measurement.

The measurement of fluidity of toner is performed as follows:
A predetermined amount of toner is supplied into a container used for the measurement;
The container is placed in the measuring device;
The conical rotor is rotated; and
The conical rotor is stuck into the toner powder layer.

The conical rotor may move vertically before the measurement so that a uniform condition in the toner powder layer can be prepared.

The toner powder layer may be compressed to form a compressed toner powder layer for the measurement.

The fluidity of toner in the compressed toner powder layer is measured under the conditions as follows:
The number of rotations of conical rotor is set to 1.0 rpm, the speed of entry of conical rotor is set to 1.0 mm/min, the pressure applied to toner powder layer is set to 0.1 kg/cm2 or more for 60 or more seconds, and the angle of circular cone of the conical rotor is 30 degrees.

As a result, cleanability is good when the rotation torque of the conical rotor is equal to or greater than 1.5* 10⁻³ Nm, and preferably equal to or greater than 2.0*10⁻³ Nm. The above-described value is preferable because when the cleaning blade 61 is in operation, toner may remain in the vicinity of the contact point of the cleaning blade 61 and the photoconductive element 1. When the toner remaining at the contact point contacts with the toner conveyed on the surface of the photoconductive element 1, if the frictional force between the toner remaining at the contact point and the toner conveyed, the toner conveyed is easily removed.

Now, a porosity of the toner powder layer is described.

As shown in FIG. 2, the toner put in the container of the measurement device is compressed at a constant force. In the present invention, the constant force for compression is set to 1.6 kg. The porosity of the toner powder layer is obtained in a following relation:
ε=(V−M/ρ)/V
where “ε” is the porosity, “V” is the volume of the toner powder layer, “M” is the mass of toner particles filled in the container of the measurement device, and “ρ” is the absolute specific gravity of toner powder.

The greater the result obtained by the above-described relation is, the better the cleanability becomes. That is, it is believed that when the value of the porosity becomes smaller, more toner particles remain at a leading edge of the cleaning blade, thereby the cleaning blade 61 is put upward enough for the toner particles to easily pass through the space between the cleaning blade 61 and the photoconductive element 1.

Generally, toner includes not only toner particles but also organic-inorganic additives, for example, silica, titanium oxide, etc. If the characteristics of mother toner and toner generated after mixing the additive with the mother toner are controlled, the cleanability becomes more stable. The additives are usually used to enhance the fluidity of toner. When the fluidity of toner becomes better, the friction coefficient between the toner particles may be reduced, thereby reducing the torque generated by the conical rotor of the present invention.

In general, the volume-based average particle diameter Dv equal to or less than 8 μm is preferably used, such that a high definition image can be produced. To avoid deterioration of developing and cleaning properties, it is preferable that the toner has the volume-based average particle diameter Dv of greater than 3 μm. Further, when the volume-based average particle diameter Dv is less than 3 μm, the toner may include a large amount of extremely small toner particles that are difficult to be in contact with the carrier or developing roller. Under the above-described condition, the toner particles other than the extremely small toner particles have insufficient contact or friction with the carrier or developing roller, which may produce irregular charge toners, resulting in defect images having background contamination, etc.

Particle diameter distribution of toner indicated based on a ratio of the volume-based average particle diameter Dv to a number-based average particle diameter Dn is preferable to be in a range from approximately 1.05 to approximately 1.40. A sharp control of the distribution of the toner particle diameters, the distribution of the toner charge becomes uniform and the irregular charge toner can be reduced. When the ratio Dv/Dn is greater than 1.40, the amount of the irregular charge toner becomes large and it becomes hard to produce an image having high resolution and high quality. A toner particle having the ratio Dv/Dn less than 1.05 is difficult to produce and is impractical to use. The above-described particle diameter of toner can be measured by, for example, a Coultar counter method using a measuring instrument for measuring particle diameter distribution of toner, such as, Coultar counter multisizer (manufactured by Coulter Electronics Limted). By using the above-described measuring instrument, the particle diameter of toner may be obtained with a 50 μm aperture, by measuring the average of particle diameters of 50,000 toner particles.

It is preferable that a shape factor “SF-1” of the toner is from approximately 100 to approximately 180, and a shape factor “SF-2” of the toner is from approximately 100 to approximately 180.

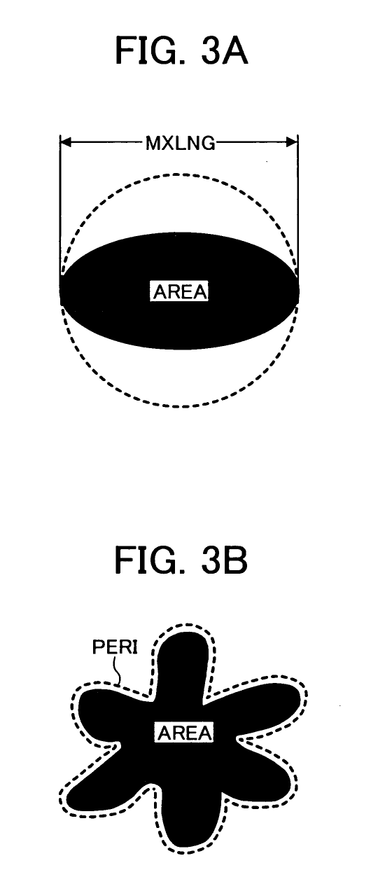

Referring to FIG. 3A, the shape factor “SF-1” is a parameter representing the roundness of a particle in FIG. 3A, and the shape factor “SF-2” is a parameter representing the roundness of a particle in FIG. 3B.

The shape factor “SF-1” of a particle is calculated by the following equation:
SF-1={(MXLNG)²/AREA}×(100π/4)
where “MXLNG” represents the maximum major axis of an elliptical-shaped figure obtained by projecting a toner particle on a two dimensional plane, and “AREA” represents the projected area of elliptical-shaped figure.

When the value of the shape factor “SF-1” is 100, the particle has a perfect spherical shape. As the value of the “SF-1” increases, the shape of the particle becomes more elliptical.

Referring to FIG. 3B, the shape factor “SF-2” is a value representing irregularity (i.e., a ratio of convex and concave portions) of the shape of the material. The shape factor “SF-2” of a particle is calculated by the following equation:
SF-2={(PERI)²/AREA}×(100/4π)
where “PERI” represents the perimeter of a figure obtained by projecting a toner particle on a two dimensional plane.

When the value of the shape factor “SF-2” is 100, the surface of the material is even (i.e., no convex and concave portions). As the value of the “SF-2” increases, the surface of the material becomes uneven (i.e., the number of convex and concave portions increase).

In this embodiment, toner images are sampled by using a field emission type scanning electron microscope (FE-SEM) S-800 manufactured by Hitachi, Ltd. The toner image information is analyzed by using an image analyzer (LUSEX3) manufactured by Nireko, Ltd.

As the toner shape becomes spherical, a toner particle becomes held in point-contact with another toner particle or the photoconductive element 1. Under the above-described condition, the toner adhesion force between two toner particles may decrease, resulting in the increase in toner fluidity, and the toner adhesion force between the toner particle and the photoconductive drum 1 may decrease, resulting in the increase in toner transferability. And, the cleaning mechanism may easily remove the toner particles remaining on the surface of the photoconductive drum 1.

Further, considering cleaning performance, it is preferable that the values of the shape factors “SF1” and “SF2” exceed 100. As the values of the shape factors “SF1” and “SF2” become greater, the toner charge distribution becomes greater and a load to the temporary toner storing mechanism becomes greater. Therefore, the values of the shape factors “SF1” and “SF2” are preferable to be less than 180.

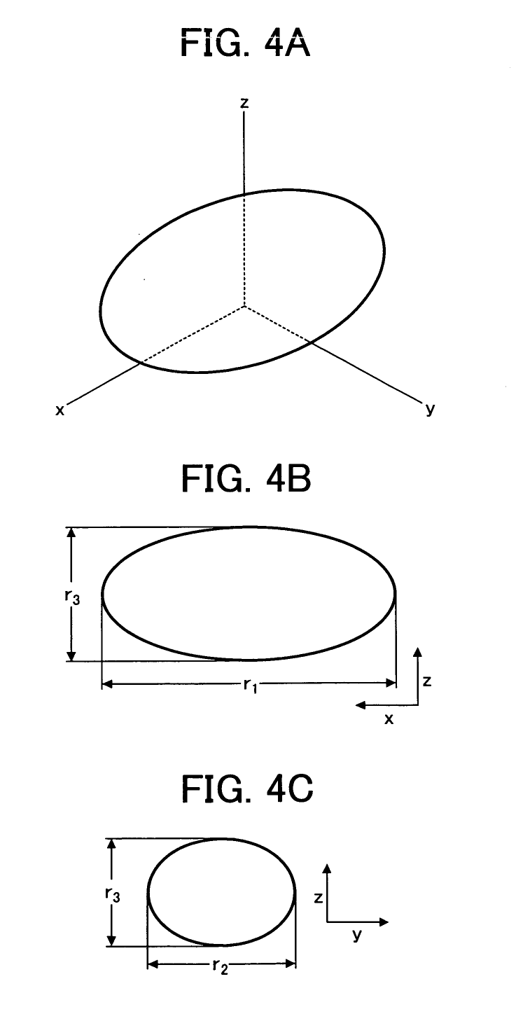

Further, the toner used in the image forming apparatus 1 may be substantially spherical. Referring to FIGS. 4A, 4B and 4C, sized of the toner is described. An axis x of FIG. 4A represents a major axis r1 of FIG. 4B, which is the longest axis of the toner. An axis y of FIG. 4A represents a minor axis r2 of FIG. 4B, which is the second longest axis of the toner. The axis z of FIG. 4A represents a thickness r3 of FIG. 4B, which is a thickness of the shortest axis of the toner. The toner has a relationship between the major and minor axes r1 and r2 and the thickness r3 as follows:
r1≧r2≧r3.

The toner of FIG. 4A is preferably in a spindle shape in which the ratio (r2/r1) of the major axis r1 to the minor axis r2 is approximately 0.5 to approximately 0.8, and the ratio (r3/r2) of the thickness r3 to the minor axis is approximately 0.7 to approximately 1.0.

When the ratio (r2/r1) is less than approximately 0.5, the toner has an irregular particle shape, and the value of the toner charge distribution increases.

When the ratio (r3/r2) is less than approximately 0.7, the toner has an irregular particle shape, and the value of the toner charge distribution increases. When the ratio (r3/r2) is approximately 1.0, the toner has a substantially round shape, and the value of the toner charge distribution decreases.

The lengths showing with r1, r2 and r3 can be monitored and measured with scanning electron microscope (SEM) by taking pictures from different angles.

The shape of toner depends on the manufacturing method used. For example, a toner particle produced by a dry type grinding method has an irregular shape with an uneven surface. The irregular-shaped toner, however, can be modified to an approximately round toner by being subjected to a mechanical treatment or a thermal treatment. Toner produced by a method such as a suspension polymerization method and an emulsion polymerization method may have a smooth surface and a perfectly spherical form. In this regard, spherical form can be charged to elliptic form by performing agitating in a middle of reaction, i.e., applying a shearing force to the toner.

A toner having a substantially spherical shape is preferably prepared by a method in which a toner composition dissolved or dispersed in an organic solvent, including a polyester prepolymer having a function group including a nitrogen atom, a polyester, a colorant, and a releasing agent is subjected to an elongation reaction and/or a crosslinking reaction in an aqueous medium in the presence of fine resin particles.

Toner constituents and preferable manufacturing method of the toner of the prevent invention will be described below.

Examples of binder resins are polystyrene resins, epoxy resins, polyester resins, polyamid resins, styrene acrylic resins, styrene methacrylate resins, polyurethane resins, vinyl resins, polyolefin resins, styrene butadiene resins, phenolic resins, polyethylene resins, silicon resins, butyral resins, terpene resins, and polyol resins.

Specific examples of vinyl resins are styrene polymers and substituted styrene polymers such as polystyrene, poly-p-chlorostyrene and polyvinyltoluene; styrene copolymers such as styrene-p chlorostyrene copolymers, styrene-propylene copolymers, styrene-viniltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene vinyl methyl ether copolymers, styrene vinyl ethyl ether copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, etc.

Polyester resin is produced by the condensation polymerization reaction of a dihydric alcohol compound in Group A as shown below with a dibasic acid compound in Group B as shown below. Further, a polyhydric alcohol compound higher than trihydric alcohol or a polyhydric carboxylic acid compound may be added.

Group A: ethylene glycol, triethylene glycol, 1,2-propylene glycol, 1,3-propylene glycol, 1,4-butanediol, neopentyl glycol, 1,4-butenediol, 1,4-bis(hydroxymethyl) cyclohexane, bisphenol A, hydrogenerated bisphenol A, polyoxypropylene bisphenol A, polyoxypropylene(2,2)2,2′-bis(4-hydroxyphenyl)propane, polyoxypropylene(3,3)-2,2-bis(4-hydroxyphenyl)propane, polyoxyethylene(2,0)-2,2-bis(4-hydroxyphenyl)propane, polyoxypropylene(2,0)-2,2′-bis(4-hydroxyphenyl)propane, etc.

Group B: maleic acid, fumaric acid, mesaconinic acid, citraconic acid, itaconic acid, glutaconic acid, phthalic acid, isophthalic acid, terephthalic acid, cyclohexanedicarboxylic acid, succinic acid, adipic acid, sebacic acid, malonic acid, linoleic acid, esters such as acid anhydride and lower alcohol, etc.

Group C: polyhydric alcohol higher than trihydric alcohol such as glycerol, trimethylol propane, pentaerythritol; a polyhydric carboxylic acid higher than trihydric carboxylic acid such as trimellitic acid, pyromellitic acid.

Examples of polyol resins are epoxy resins, adducts of epoxy resin and dihydric phenol with alkylene oxide, or reaction products of a compound having one active hydrogen reacting with glycidyl ether and epoxy group in a molecule and a compound having two or more active hydrogen reacting with epoxy group.

Suitable colorants for use in the toner of the present invention include known dyes and pigments.

Specific examples of the colorant having black color include pigments of azine family such as carbon black, oil furnace black, channel black, lamp black, acetylene black, and aniline black; pigments of azo metallic chloride; black iron ozide; and metallic oxide compound.

Specific examples of the colorant having yellow color include Cadmium Yellow, Mineral Fast Yellow, Nickel Titan Yellow, Naples Yellow, Naphthol Yellow S, Hansa Yellow G, Hansa Yellow 10G, Benzidin Yellow GR, Quinoline Yellow Lake, Permanent Yellow NCG, Tartrazine Lake, and the like.

Specific examples of the colorant having orange color include Molybdenum Orange, Permanent Orange GTR, Pyrazolone Orange, Vulcan Orange, Indanthrene Brilliant Oreng RK, Benzidine Orange G, Indanthrene Brilliant Orange GK, and the like.

Specific examples of the colorant having red color include red iron oxide, cadmium red, Permanent Red 4R, Lithole Red, Pyrazolone Red, Watching Red Calcium Salt, Lake Red D, Brilliant Carmine 6B, Eosin Lake, Rhodamine Lake B, Alizarine Lake, Brilliant Carmine 3B, and the like.

Specific examples of the colorant having violet color include Fast Violet B, Methyl Violet Lake, and the like.

Specific examples of the colorant having blue color include cobalt blue, Alkali Blue, Victoria Blue Lake, Phthalocyanine Blue, metal-free Phthalocyanine Blue, Phthalocyanine Blue Subchlorinated compound, Fast Sky Blue, Indanthrene Blue BC, and the like.

Specific examples of the colorant having green color include Chrome Green, chromium oxide, Pigment Green B, Malachite Green Lake, and the like.

These materials are used alone or in combination.

The colorants mentioned above for use in present invention can be used as master batch pigments by being combined with a resin. Especially for color toner, it is necessary the colorant be uniformly dispersed in good condition. The color toner is not manufactured by directly combining a large amount of colorant with the resin, but by firstly preparing the master batch pigment containing the colorant substantially dispersed in high density, and diluting the master batch to be combined with the resin.

The toner of the present invention may further include a charge controlling agent. The charge controlling agent can be internally or externally mixed with the toner according to necessity. The charge controlling agent can control an electrical charge according to the developing system of the image forming apparatus. In the present invention, a relationship of particle size distribution and the electrical charge may be more stable.

Specific examples of the charge controlling agents for controlling the toner to a positive electric charge include nigrosin based dyes, quaternary ammonium salts, triphenylmethane based dyes, imidazole metal complex and salts, etc. These materials are used alone or in combination.

Specific examples of the charge controlling agents for controlling the toner to a negative electric charge include salicylic acid metal complex and salts, organic boron salts, calixarene compound, etc.

The toner for use in the image forming apparatus of the present invention may include a releasing agent for preventing an offset at fixing.

Specific examples of the releasing agent include natural waxes such as candelilla wax, carnauba wax, and rice wax; montan waxes and their derivatives, paraffin waxes and their derivatives, polyolefin waxes and their derivatives, Southall wax, low molecular weight polyethylene, low molecular weight polypropylene, alkyl phosphate ester, etc. Suitable release agents include these waxes having a melting point of from approximately 65 degree Celsius to approximately 120 degree Celsius. When the melting point is lower than 65 degree Celsius, a blocking may occur while the toner is reserved. When the melting point is higher than 90 degree Celsius, the offset may easily occur in an area applied with a low temperature of a fixing roller.

Additives may be added for the purpose of increasing dispersibility of the releasing agent.

Specific examples of the additives include styrene-acrylic resin, polyethylene resin, polystyrene resin, epoxy resin, polyester resin, polyamide resin, styrene-methacrylate resin, polyurethane resin, vinyl resin, polyolefin resin, styrene-butadiene resin, phenolic resin, butyral resin, terpene resin, polyol resin, and a combination of two or more of them.

The toner for use in the image forming apparatus according to the present invention may be prepared according to procedures including, but not being limited to, pulverization, polymerization including suspension polymerization, emulsion polymerization, dispersion polymerization, emulsion condensation, emulsion association, or the like.

The toner for use in the image forming apparatus according to the present invention may control the surface of the toner particles by embedding the small toner particles into the mother toner particles. The toner may be prepared by mixing organic resin particles or inorganic fine particles having each amount not more than one-tenth of the mother toner particles and fixing the mixture on a surface of the mother toner particles by heat so that the toner may have a subtly shriveled surface.

Inorganic fine particles can be preferably used as the external additive. The inorganic fine particles including the hydrophobic inorganic fine particles have an average particle diameter of a primary particle preferably from approximately 1 nm to approximately 100 nm, and more preferably from approximately 5 nm to approximately 70 nm and have a specific surface area as determined by the BET method of preferably from 20 m²/g to 500 m²/g.

The toner of the present invention may optionally include an additive such as silica fine particles, hydrophobic silica, fatty acid metal salts (zinc stearate, aluminum stearate, etc.), hydrophobic metal oxides (titania, alumina, tin oxide, antimony oxide, etc.) and fluoropolymers. In particular, hydrophobized fine particles of silica, titania, titanium oxide, and alumina are preferably used. Specific examples of the marketed products of the hydrophobizing agents include silica fine particles, titania fine particles, fine particle of titanium oxide, and alumina fine particles. Specific examples of the silica fine particles are HDK H 2000, HDK H 2000/4, HDK H 2050EP, HVK21 and HDK H 1303 (trade names, available from Clariant Japan Co., Ltd.), R972, R974, RX200, RY200, R202, R805 and R812 (trade names, available from Nippon Aerosil Co.). Specific examples of the titania fine particles are P-25 (trade name, available from Nippon Aerosil Co.), STT-30 and STT-65C-S (trade names available from Titan Kogyo K.K.), TAF-140 (trade name, available from Fuji Titanium Industry Co., Ltd.), MT=150W, MT-500B, MT-600B and MT-150A (trade names, available from Tayca Corp.). Specific examples of the fine particles of hydrophobized titanium oxide are T-805 (trade name, available from Nippon Aerosil Co.), STT-30A and STT-65S-S (trade names, available from Titan Kogyo K.K.), TAF-500T and TAF-1500T (trade names, available from Fuji Titanium Industry Co., Ltd.), MT-100S and MT-100T (trade names, available from Tayca Corp.) and IT-S (trade name, available from Ishihara Sangyo Kaisha, Ltd.).

Following shows Examples 1 and 2 of tests performed for evaluating a relationship between toner and cleanability.

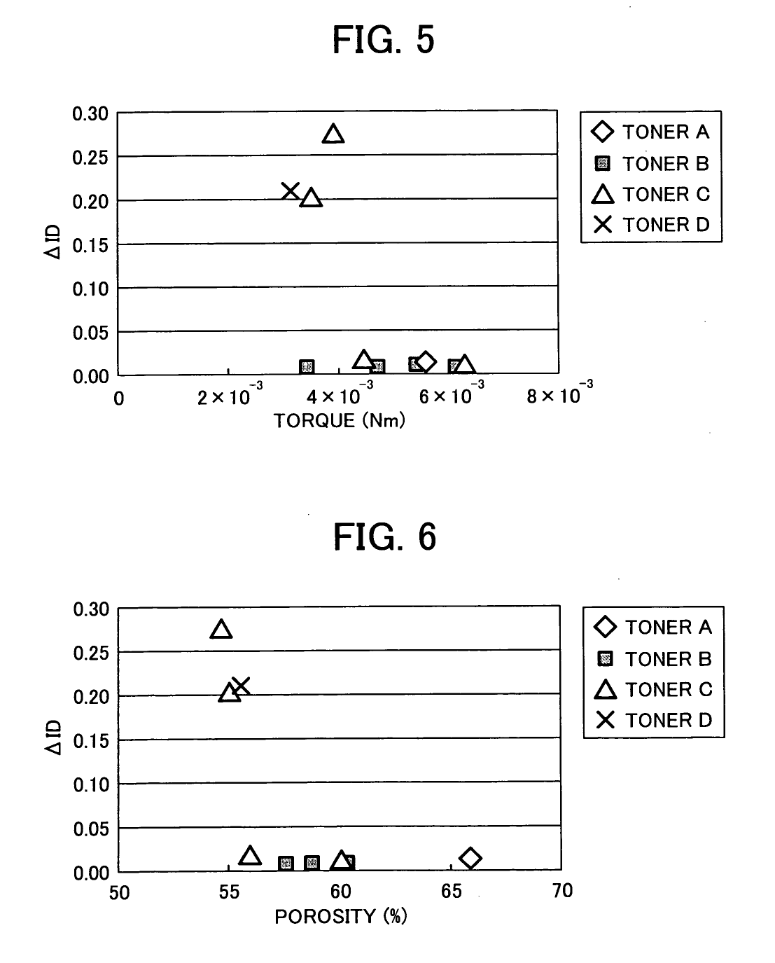

In Example 1, a relationship of an image density (ID) of toner remaining on the surface of the photoconductive element and a torque and porosity of toner was evaluated with the toner obtained by the above-described evaluating method, with reference to FIGS. 5 and 6.

Firstly, one cycle of a developing operation was performed to form a solid toner layer on a surface of the photoconductive element under the following conditions that the developing bias is set to 100V, and the toner layer ID is set to approximately 0.5.

Next, the developing unit was separated from the photoconductive element, and a cleaning blade was arranged in contact with the surface of the photoconductive element.

With the cleaning blade attached, the photoconductive element was rotated for six times (equal to one developing cycle) at a linear speed of IPSiO CX8200, the test machine, and the toner was transferred on a tape.

Then, an amount of residual toner was evaluated as ΔID of the toner transferred on the tape.

And, values of porosities that were compressed at a constant force of 1.6 kg (Condition 6) and values of torques were compared with the above-described cleaning remaining ΔID.

The conditions of the test of Example 1 were as follows:
The test machine used for the test was IPSiO CX8200. IPSiO CX8200 included a lubricant applied to a surface of the photoconductive element with a brush, and a cleaning blade, T7050 (manufactured by Toyo Tire and Rubber Co., Ltd.). The following four types of toners were used in the test: Toner A (0.90), Toner B (0.93), Toner C (0.97), and Toner D (0.98), where the figures described in round brackets indicate toner circularity. The torques and porosities in the toner powder layer including a mother toner before mixing additives are measured by using the instrument with a conical rotor for evaluating fluidity of toner (see FIG. 2). In the evaluation with IPSiO CX8200 of Example 1, the toner was used after mixing additives.

Referring to FIG. 5, a graph showing a relationship of a property of torques of toners and the cleaning remaining ΔID obtained by the test performed in Example 1 is described.

In the graph of FIG. 5, when the torque value is equal to or less than 4*10−3 (Nm), the cleaning remaining ΔID is large. When the cleaning remaining ΔID becomes equal to or greater than 0.1, a charging roller arranged in the test machine becomes substantially contaminated, which may generate defect images. Therefore, it is preferable that the cleaning remaining ΔID is equal to or smaller than 0.1.

Referring to FIG. 6, a graph showing a relationship of a property of compressed toner (hereinafter, referred to as a porosity) and the cleaning remaining ΔID is described.

In the graph of FIG. 6, when the porosity is equal to or lower than 55%, the cleaning remaining ΔID is large.

TABLE 1
Measurement result values for to FIGS. 5 and 6

| | | Porosity | Torque | Average of |
|---|---|---|---|---|
| Toner Type | Toner Name | (%) | (Nm) | ΔID |
| Toner A | a | 65.859 | 5.57E−03 | 0.008 |
| Toner B | b | 58.626 | 6.16E−03 | 0.006 |
| | c | 60.262 | 5.44E−03 | 0.008 |
| | d | 58.597 | 3.37E−03 | 0.013 |
| | e | 57.543 | 4.69E−03 | 0.006 |
| Toner C | f | 60.027 | 6.24E−03 | 0.004 |
| | g | 54.58 | 3.90E−03 | 0.276 |
| | h | 54.917 | 3.48E−03 | 0.204 |
| | i | 56.184 | 4.50E−03 | 0.021 |
| Toner D | j | 55.473 | 3.09E−03 | 0.209 |

Toners A, B, C and D have different average circularity to each other. That is, toner names b, c, d and e of Toner B have an identical average circularity, and toner names f, g, h and i of Toner C have an identical average circularity.

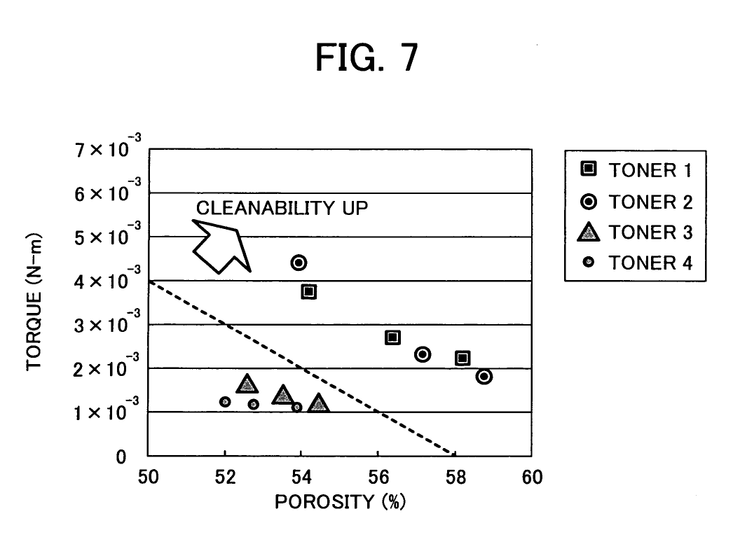

In Example 2, a relationship of the torques and porosities of toners in accordance with the cleanability was evaluated based on the result of Example 1, with reference to FIG. 7.

The conditions of the test of Example 2 were as follows:
The test machine used for the test of Example 2 was IPSiO CX8200. IPSiO CX8200 included a lubricant applied to a surface of the photoconductive element with a brush, and a cleaning blade, T7050 (manufactured by Toyo Tire and Rubber Co., Ltd.). The following four types of toners were used in the test: Toner 1, Toner 2, Toner 3, and Toner 4. The torques and porosities in the toner powder layer after mixing additives are measured by using the instrument with a conical rotor for evaluating fluidity of toner (see FIG. 2). In the evaluation with IPSiO CX8200 of Example 2, the toner was used after mixing additives.

Referring to FIG. 7, a graph showing the results of the tests obtained by the test performed in Example 2 according to the exemplary embodiment is described. In the graph of FIG. 7, values of the torques and porosities of the toners are plotted to show their relationship with the cleanability. As shown in FIG. 7, the cleanability is divided by a dotted line into two different conditions. That is, Toners 1 and 2 used above the dotted line were cleaned better than Toners 3 and 4 used below the dotted line. The condition of high cleanability can be determined by the following expression:
Y≧−0.05X+0.029

where “X” expresses a porosity of the toner powder layer after uniformly compressed at a constant force and “Y” expresses a torque value obtained by rotatably sticking the conical rotor into the toner powder layer.

TABLE 2
Measurement result values for to FIG. 7

| | | Porosities | Torque |
|---|---|---|---|
| Toner 1 | Condition 1 | 58.2 | 2.25E−03 |
| | Condition 2 | 56.4 | 2.74E−03 |
| | Condition 6 | 54.2 | 3.75E−03 |
| Toner 2 | Condition 1 | 58.7 | 1.88E−03 |
| | Condition 2 | 57.1 | 2.38E−03 |
| | Condition 6 | 54.0 | 4.40E−03 |
| Toner 3 | Condition 1 | 54.4 | 1.14E−03 |
| | Condition 2 | 53.4 | 1.30E−03 |
| | Condition 6 | 52.6 | 1.60E−03 |
| Toner 4 | Condition 1 | 53.7 | 1.10E−03 |
| | Condition 2 | 52.7 | 1.21E−03 |
| | Condition 6 | 51.9 | 1.29E−03 |

Four types of toners, Toners 1, 2, 3 and 4, are used. In Table 2, Conditions 1, 2 and 6 represent respective constant forces, 0.25 kg, 0.5 kg and 1.6 kg applied for the measurement. As shown in FIG. 2, the toner powder layer is pressed at a constant force before the measurement, and respective conditions show the respective constant forces. In Example 1, Condition 6 (1.6 kg) was applied to Toners A, B, C and D for the measurement.

According to the present invention, an image forming apparatus with a blade cleaning method may provide high image quality, enhance high cleanability and prevent deterioration of a cleaning blade from abrasion while using spherical or substantially spherical toner particles.

Numerous additional modifications and variations are possible in light of the above teachings. It is therefore to be understood that within the scope of the appended claims, the disclosure of this patent specification may be practiced otherwise than as specifically described herein.

1. An image forming apparatus comprising:
an image bearing member configured to bear an electrostatic latent image on a surface thereof;
a developer containing toner configured to develop the electrostatic latent image formed on the surface of the image bearing member into a toner image with said toner;
a transferor configured to transfer the toner image from the image bearing member to an image receiver; and
a cleaner comprising a cleaning blade and configured to remove a residual toner on the surface of the image bearing member after the toner image is transferred to the image receiver;
wherein the toner comprises:
binder resin; and
colorant, and
wherein the toner forms a toner powder layer and satisfies an inequality Y≧−0.05X+0.029, in which “X” expresses a porosity of the toner powder layer after uniformly compressed at a constant force and “Y” expresses a torque value obtained by rotatably sticking a conical rotor into the toner powder layer.

2. The image forming apparatus according to claim 1, wherein the cleaning blade has a JIS-A hardness equal to or more than 65.

3. The image forming apparatus according to claim 1, wherein the image forming apparatus comprises toner obtained from at least one of elongation and crosslinking reaction of toner composition in an organic solvent and comprising a polyester prepolymer having a function group including nitrogen atom, a polyester, a colorant, and a releasing agent in an aqueous medium under resin fine particles.

4. The image forming apparatus according to claim 1, wherein the toner has an average circularity of from approximately 0.93 to approximately 1.00.

5. The image forming apparatus according to claim 1, wherein the toner has a volume-based average particle diameter equal to or less than 10 μm and a distribution from approximately 1.00 to approximately 1.40, wherein the distribution is defined by a ratio of the volume-based average particle diameter to a number-based average particle diameter.

6. The image forming apparatus according to claim 1, wherein the toner has a spindle outer shape, and a ratio of a major axis r1 to a minor axis r2 from approximately 0.5 to approximately 1.0 and a ratio of a thickness r3 to the minor axis r2 from approximately 0.7 to approximately 1.0, and r1≧r2≧r3.

7. An image forming apparatus for electrophotographic image forming, comprising:
means for bearing an electrostatic latent image on a surface thereof;
means for developing the electrostatic latent image formed on the surface of the image bearing member into a toner image by using a toner, said means for developing containing toner;
means for transferring the toner image from the means for bearing to an image receiver; and
means for cleaning comprising a cleaning blade and removing a residual toner on the surface of the means for bearing after the toner image is transferred to the image receiver;
wherein the toner comprises:
binder resin; and
colorant, and
wherein the toner forms a toner powder layer and satisfies an inequality Y≧−0.05X+0.029, in which “X” expresses a porosity of the toner powder layer after uniformly compressed at a constant force and “Y” expresses a torque value obtained by rotatably sticking a conical rotor into the toner powder layer.

8. The image forming apparatus according to claim 7, wherein the cleaning blade has a JIS-A hardness equal to or more than 65.

9. The image forming apparatus according to claim 7, wherein the toner is obtained from at least one of elongation and crosslinking reaction of toner composition in an organic solvent and comprising a polyester prepolymer having a function group including nitrogen atom, a polyester, a colorant, and a releasing agent in an aqueous medium under resin fine particles.

10. The image forming apparatus according to claim 7, wherein the toner has an average circularity of from approximately 0.93 to approximately 1.00.

11. The image forming apparatus according to claim 7, wherein the image forming apparatus is configured to use the toner having a volume-based average particle diameter equal to or less than 10 μm and a distribution from approximately 1.00 to approximately 1.40, wherein the distribution is defined by a ratio of the volume-based average particle diameter to a number-based average particle diameter.

12. The image forming apparatus according to claim 7, wherein the toner has a spindle outer shape, and a ratio of a major axis r1 to a minor axis r2 from approximately 0.5 to approximately 1.0 and a ratio of a thickness r3 to the minor axis r2 from approximately 0.7 to approximately 1.0, and r1≧r2≧r3.

13. A method of electrophotographic image forming, comprising:
forming an electrostatic latent image on a surface of an image bearing member;
developing a toner image with a toner based on the electrostatic latent image formed on the surface of the image bearing member;
transferring the toner image with a transfer mechanism from the image bearing member to an image receiver; and
removing a residual toner on the surface of the image bearing member using a cleaning blade after the toner image is transferred to the image receiver,
wherein the toner comprises a binder resin and a colorant, and
wherein the toner forms a toner powder layer and satisfies an inequality Y≧−0.05X+0.029, in which “X” expresses a porosity of the toner powder layer after uniformly compressed at a constant force and “Y” expresses a torque value obtained by rotatably sticking a conical rotor into the toner powder layer.

14. A toner comprising:
binder resin; and
colorant,
wherein the toner forms a toner powder layer and satisfies an inequality Y≧−0.05X+0.029, in which “X” expresses a porosity of the toner powder layer after uniformly compressed at a constant force and “Y” expresses a torque value obtained by rotatably sticking a conical rotor into the toner powder layer.

15. The toner according to claim 14, wherein the toner is obtained from at least one of elongation and crosslinking reaction of toner composition in an organic solvent and comprising a polyester prepolymer having a function group including nitrogen atom, a polyester, a colorant, and a releasing agent in an aqueous medium under resin fine particles.

16. The toner according to claim 14, wherein the toner has an average circularity of from approximately 0.93 to approximately 1.00.

17. The toner according to claim 14, wherein the toner has a volume-based average particle diameter equal to or less than 10 μm and a distribution from approximately 1.00 to approximately 1.40, wherein the distribution is defined by a ratio of the volume-based average particle diameter to a number-based average particle diameter.

18. The toner according to claim 14, wherein the toner has a spindle outer shape, and a ratio of a major axis r1 to a minor axis r2 from approximately 0.5 to approximately 1.0 and a ratio of a thickness r3 to the minor axis r2 from approximately 0.7 to approximately 1.0, and r1≧r2≧r3.
